(19) United States
(12) Patent Application Publication
(10) Pub. No.: US 2018/0210112 A1
(43) Pub. Date: Jul. 26, 2018

(54) THREE DIMENIONAL NEGATIVE REFRACTION STRUCTURE AND MANUFACTURING METHOD THEREOF

(71) Applicant: National Tsing Hua University, Hsinchu City (TW)

(72) Inventors: Ta-Jen Yen, Hsinchu City (TW); Ting-Tso Yeh, Kaohsiung City (TW); Tsung-Yu Huang, Hsinchu City (TW)

(73) Assignee: National Tsing Hua University, Hsinchu City (TW)

(21) Appl. No.: 15/486,680

(22) Filed: Apr. 13, 2017

(30) Foreign Application Priority Data
Jan. 20, 2017 (TW) 106102022

(51) Int. Cl. G02B 1/00

(52) U.S. Cl. CPC G02B 1/007

(57) ABSTRACT

The invention provides a three-dimensional negative refraction structure and a manufacturing method thereof. The three-dimensional negative refraction structure includes at least one metal shell. The at least one metal shell is embedded in a substrate or disposed on the substrate. A shape of the at least one metal shell is a three-dimensional symmetrical shape.

### CROSS-REFERENCE TO RELATED APPLICATION

This application claims the priority benefit of Taiwan application serial no. 106102022, filed on Jan. 20, 2017. The entirety of the above-mentioned patent application is hereby incorporated by reference herein and made a part of this specification.

### FIELD OF THE INVENTION

The invention relates to a three-dimensional negative refraction structure. More particularly, the invention relates to a three-dimensional negative refraction structure with three-dimensional symmetry.

### DESCRIPTION OF RELATED ART

A negative refraction structure is an artificial medium with supernormal physical properties that can not be found in natural materials, such as negative permittivity, negative permeability, and negative refractive index as well as applications including electromagnetic invisibility, sub-wavelength focusing, and sub-wavelength waveguide. In recent years, comprehensive studies on the negative refraction structure have been made; nevertheless, new challenges have emerged. For example, currently, negative refractive index effect can be generated by the negative refraction structure only for an electromagnetic wave with a single incident angle or with a limited range of incident angles. Thus, it can be seen that applications of the negative refraction structure are limited.

### SUMMARY OF THE INVENTION

The invention provides a three-dimensional negative refraction structure and a manufacturing method thereof. The three-dimensional negative refraction structure can be applied to electromagnetic waves with various incident angles.

In an embodiment of the invention, the three-dimensional negative refraction structure includes at least one metal shell. The at least one metal shell is embedded in a substrate or disposed on the substrate. A shape of the at least one metal shell is a three-dimensional symmetrical shape.

In an embodiment of the invention, the substrate may have at least one three-dimensional symmetrical recess, and the at least one metal shell is conformally disposed in the at least one three-dimensional symmetrical recess.

In an embodiment of the invention, a shape of the at least one three-dimensional symmetrical recess and the shape of the at least one metal shell may include a hemispherical shape or a cube shape.

In an embodiment of the invention, the three-dimensional negative refraction structure may further include at least one support structure, and the at least one metal shell may be conformally disposed on the at least one support structure. A shape of the at least one support structure is a three-dimensional symmetrical shape.

In an embodiment of the invention, the shape of the at least one support structure may include a spherical shape.

In an embodiment of the invention, a material of the substrate may include an insulating material or a semiconductor material.

In an embodiment of the invention, a width of the at least one metal shell may be 0.8 to 0.9 times of a wavelength at which a negative refractive index effect to be generated.

In an embodiment of the invention, a side of the substrate opposite to the at least one metal shell may have a back-side recess.

In an embodiment of the invention, the at least one metal shell may include a plurality of metal shells.

In an embodiment of the invention, a gap between adjacent metal shells may be 0.1 to 0.5 times of a wavelength at which a negative refractive index effect to be generated.

In an embodiment of the invention, a manufacturing method of a three-dimensional negative refraction structure includes embedding at least one metal shell in a substrate or forming the at least one metal shell on the substrate. A shape of the at least one metal shell is a three-dimensional symmetrical shape.

In an embodiment of the invention, the manufacturing method of the three-dimensional negative refraction structure may further include forming a three-dimensional symmetrical recess at a surface of the substrate and forming the at least one metal shell conformally in the at least one three-dimensional symmetrical recess.

In an embodiment of the invention, a method of forming the at least one three-dimensional symmetrical recess may include the following steps. A first mask layer and a second mask layer are sequentially formed on the substrate. The second mask layer is patterned to form at least one opening exposing the first mask layer. The first mask layer is patterned and the first mask layer exposed by the at least one opening is removed. The patterned second mask layer is removed. A portion of the substrate is removed by using the patterned first mask layer as a mask to form the at least one symmetrical recess. The patterned first mask layer is removed.

In an embodiment of the invention, a method of forming the at least one metal shell may include the following steps. A metal layer is conformally formed on the substrate and on the at least one three-dimensional symmetrical recess. A portion of the metal layer outside the at least one three-dimensional symmetrical recess on the substrate is removed to form the at least one metal shell in the at least one three-dimensional symmetrical recess.

In an embodiment of the invention, before the metal layer is formed, the manufacturing method of the three-dimensional negative refraction structure may further include forming a pad layer on the substrate and one the at least one three-dimensional symmetrical recess.

In an embodiment of the invention, a method of removing the portion of the metal shell may include the following steps. An adhesion layer is attached to the portion of the metal layer outside the at least one three-dimensional symmetrical recess. The adhesion layer and the portion of the metal layer attached to the adhesion layer are removed all together to form the at least one metal shell in the at least one three-dimensional symmetrical recess.

In an embodiment of the invention, a material of the pad layer may include silicon oxide, silicon nitride, or a combination thereof.

In an embodiment of the invention, the manufacturing method of the three-dimensional negative refraction structure may further include forming a support structure on the substrate and forming the at least one metal shell on the at least one support structure. A shape of the at least one support structure is a three-dimensional symmetrical shape.

In an embodiment of the invention, the manufacturing method of the three-dimensional negative refraction structure may further include transferring the at least one support structure and the at least one metal shell to another substrate after forming the at least one metal shell.

In an embodiment of the invention, the manufacturing method of the three-dimensional negative refraction structure may further include removing a portion of the substrate to form a back-side recess on a side of the substrate opposite to the at least one metal shell.

To sum up, the shape of the metal shell is symmetrical in three dimensions. Thus, when electromagnetic waves propagates to the three-dimensional negative refraction structure with different incident angles, an electric resonance and a magnetic resonance may both be generated at the metal shell, so that the three-dimensional negative refraction structure generates the negative refractive index effect. In addition, the wavelength at which the negative refractive index effect is generated by the three-dimensional negative refraction structure may be changed along with the incident angle of an electromagnetic wave. On the other hand, if the incident angle of the electromagnetic wave is fixed, the wavelength at which the negative refractive index effect being generated by the three-dimensional negative refraction structure may be adjusted by altering the width or the diameter of the metal shell.

To make the aforementioned and other features and advantages of the invention more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A to FIG. 1J are schematic three-dimensional views of a manufacturing process of a three-dimensional negative refraction structure according to an embodiment of the invention.

FIG. 2 is a schematic three-dimensional view of a three-dimensional negative refraction structure according to another embodiment of the invention.

FIG. 3 is a schematic cross-sectional view of a three-dimensional negative refraction structure according to still another embodiment of the invention.

### DESCRIPTION OF THE EMBODIMENTS

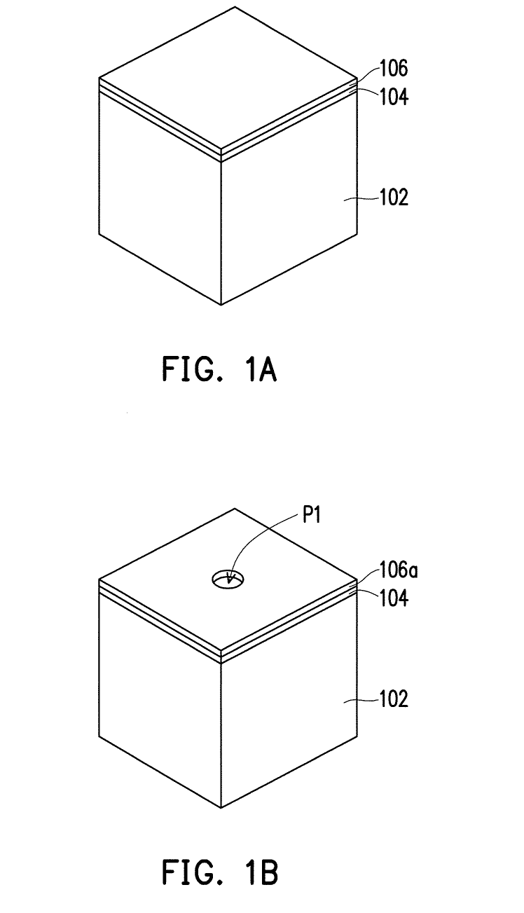

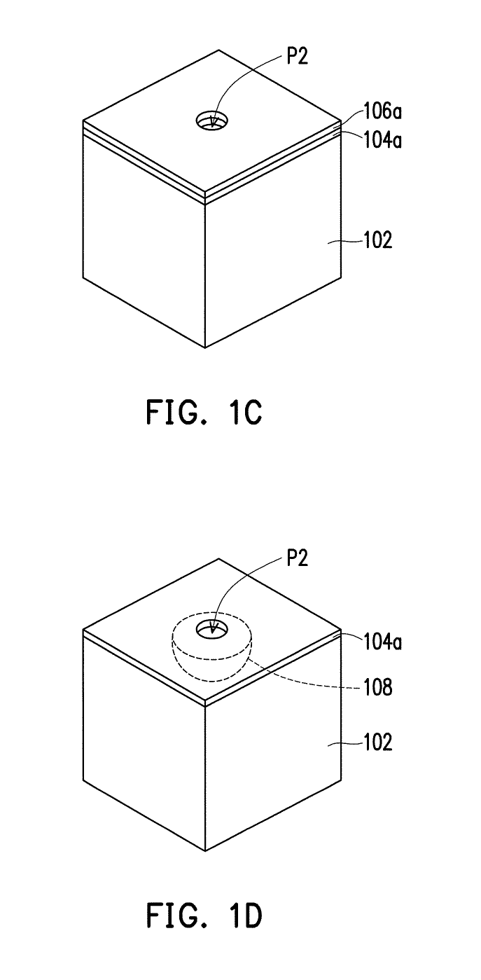

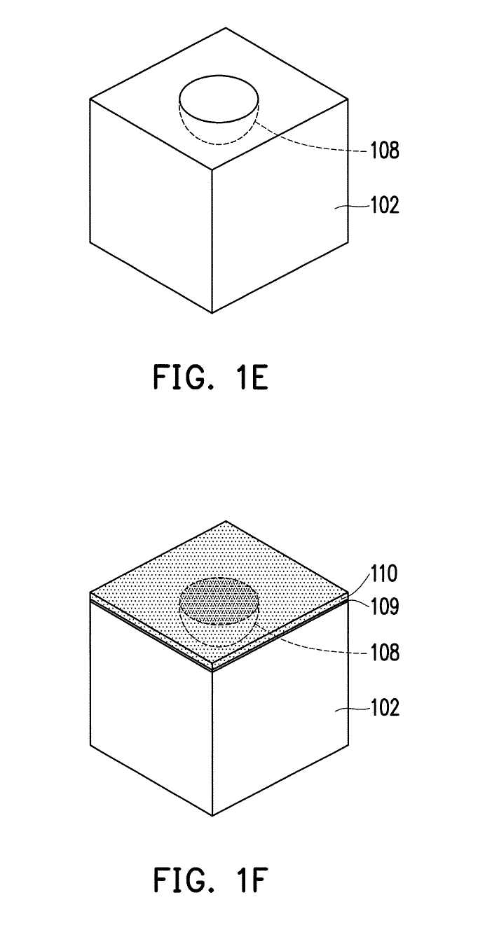

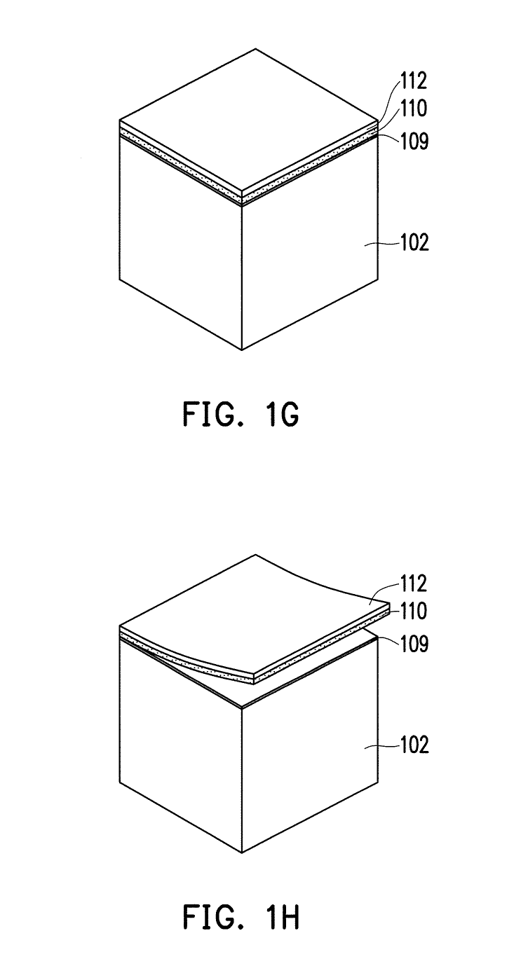

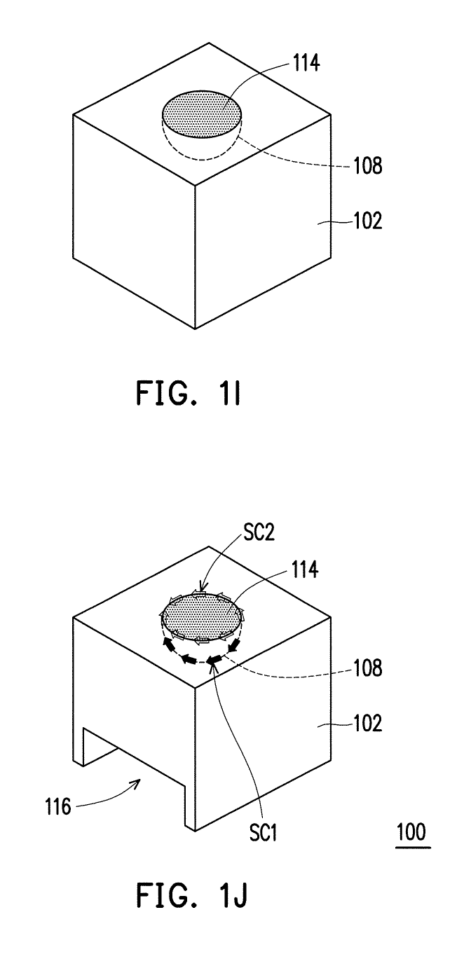

FIG. 1A to FIG. 1J are schematic three-dimensional views of a manufacturing process of a three-dimensional negative refraction structure according to an embodiment of the invention. A manufacturing method of the three-dimensional negative refraction structure of the present embodiment is to embed a three-dimensional symmetrical metal shell in a substrate, and the method may include the following steps.

Referring to FIG. 1A to FIG. 1D, firstly, a three-dimensional symmetrical recess is formed at a surface of a substrate 102. A material of the substrate 102 may include an insulating material or a semiconductor material. For example, the substrate 102 may be a silicon substrate. In some embodiments, a method of forming the three-dimensional symmetrical recess may include the following steps.

Referring to FIG. 1A, a first mask layer 104 and a second mask layer 106 may be sequentially formed on the substrate 102. In some embodiments, a material of the first mask layer 104 may include silicon oxide, silicon nitride, or a combination thereof. In alternative embodiments, the material of the first mask layer 104 may also be other materials with an etching selectivity with respect to the substrate 102. In addition, the second mask layer 106 may be a photoresist layer or other materials with an etching selectivity with respect to the first mask layer 104.

Referring to FIG. 1B, next, the second mask layer 106 may be patterned to form a patterned second mask layer 106a and an opening P1 exposing the first mask layer 104. In the present embodiment, a shape of the opening P1 may be a circle. In alternative embodiments, the shape of the opening P1 may also be a square or other symmetrical shapes.

Referring to FIG. 1C, then, the first mask layer 104 may be patterned, and the first mask layer 104 exposed by the opening P1 is removed. Thus, a patterned first mask layer 104a and an opening P2 are formed. In some embodiments, a method of removing the first mask layer 104 exposed by the opening P1 includes an anisotropic etching process. For example, the anisotropic etching process may include a reactive ion etching (RIE). Similar to the opening P1, a shape of the opening P2 of the present embodiment may also be a circle. In alternative embodiments, the shape of the opening P2 may also be a square or other symmetrical shapes.

Referring to FIG. 1D, the patterned second mask layer 106a may be subsequently removed. Then, a portion of the substrate 102 is removed by using the patterned first mask layer 104a as a mask, so as to form a three-dimensional symmetrical recess 108. In some embodiments, a method of removing the portion of the substrate 102 includes performing an isotropic etching process, such as a wet etching process. For example, if the substrate 102 is a silicon substrate, a method of performing the isotropic etching process may include performing the wet etching process by using a mixed solution containing hydrofluoric acid, nitric acid, and acetic acid. In the present embodiment, a shape of the three-dimensional symmetrical recess 108 may be a hemispherical shape. Nevertheless, in alternative embodiments, the shape of the three-dimensional symmetrical recess 108 may further be a cube or other three-dimensional symmetrical shapes. The invention is not limited thereto. In addition, a width (or a diameter) of the three-dimensional symmetrical recess 108 may be greater than or equal to a width (or a diameter) of the opening P2. In some embodiments, the width (or the diameter) of the three-dimensional symmetrical recess 108 may be 0.8 to 0.9 times of a wavelength at which a negative refraction effect to be generated. In other words, the wavelength at which the negative refraction effect being generated may be adjusted by altering the width (or the diameter) of the three-dimensional symmetrical recess 108. Furthermore, because the material of the patterned first mask layer 104a may have an etching selectivity with respect to the substrate 102, the substrate 102 can be protected while forming the three-dimensional symmetrical recess 108. Therefore, a portion of the substrate 102 outside the three-dimensional symmetrical recess 108 can be prevented from being damaged.

Referring to FIG. 1E, next, the patterned first mask layer 104a may be removed. In an embodiment, a method of removing the patterned first mask layer 104a may include performing an isotropic etching process, such as performing a wet etching process by using a hydrofluoric acid solution. Similarly, the material of the patterned first mask layer 104a may have an etching selectivity with respect to the substrate 102, such that the substrate 102 and the three-dimensional symmetrical recess 108 can be prevented from being damaged while removing the patterned first mask layer 104a.

Referring to FIG. 1F to FIG. 1I, a metal shell is then formed. In particular, the metal shell is conformally formed in the three-dimensional symmetrical recess 108. In some embodiments, a method of forming the metal shell may include the following steps.

Referring to FIG. 1F, a metal layer 110 is conformally formed on the substrate 102 and the three-dimensional symmetrical recess 108. For example, a material of the metal layer 110 may include gold or other metals with high electrical conductivity and low activity. The invention is not limited thereto. In some embodiments, the method of forming the metal shell further includes conformally forming a pad layer 109 on the substrate 102 and the three-dimensional symmetrical recess 108 before the metal layer 110 is formed. As a result, the pad layer 109 may be located between the metal layer 110 and the substrate 102. In some embodiments, a material of the pad layer 109 may include silicon oxide, silicon nitride, or a combination thereof. In alternative embodiments, the material of the pad layer 109 may also be materials with good release property with respect to the metal layer 110.

Referring to FIG. 1G to FIG. 1I, then, a portion of the metal layer 110 outside the three-dimensional symmetrical recess 108 on the substrate 102 is removed, so as to form a metal shell 114 in the three-dimensional symmetrical recess 108. In some embodiments, a method of removing the portion of the metal layer 110 includes the following steps.

Referring to FIG. 1G, firstly, an adhesion layer 112 is attached to the portion of the metal layer 110 outside the three-dimensional symmetrical recess 108. In some embodiments, the adhesion layer 112 may be an adhesive tape or other adhesive materials.

Referring to FIG. 1H and FIG. 1I, next, the adhesion layer 112 and the portion of the metal layer 110 attached to the adhesion layer 112 are removed all together. The adhesion layer is not attached to a portion of the metal layer 110 in the three-dimensional symmetrical recess 108, so that a metal layer 110 in the three-dimensional symmetrical recess 108 may be retained while removing the adhesive layer 112. Therefore, in the three-dimensional symmetrical recess 108, the metal shell 114 can be formed by the remained metal layer 110. In an embodiment, the pad layer 109 may be retained on a portion of the substrate 102 outside the three-dimensional symmetrical recess 108 and may be retained between the metal shell 114 and the three-dimensional symmetrical recess 108 (the pad layer 109 is omitted in FIG. 1I) while removing the adhesion layer 112.

Referring to FIG. 1J, next, a portion of the substrate 102 may be selectively removed to form a back-side recess 116 at a side of the substrate 102 opposite to the three-dimensional symmetrical recess 108. Now, the manufacturing of a three-dimensional negative refraction structure 100 of the present embodiment has been completed. In the present embodiment, the back-side recess 116 is disposed in correspondence with a position of the metal shell 114. Accordingly, a path of an electromagnetic wave passing through the substrate 102 from the metal shell 113 can be shortened. That is, an equivalent absorption of electromagnetic wave by the substrate 102 is reduced and a transmittance of the three-dimensional negative refraction structure 100 for electromagnetic wave is increased. In addition, a portion of the substrate 102 outside the back-side recess 116 can still retain a relatively large thickness, so as to provide the three-dimensional negative refraction structure 100 with a sufficient mechanical strength.

Next, a structure of the three-dimensional negative refraction structure 100 of the present embodiment would be described with reference to FIG. 1J. The three-dimensional negative refraction structure 100 of the present embodiment includes the substrate 102 and the metal shell 114. The metal shell 114 is embedded in the substrate 102. The shape of the metal shell 114 is a three-dimensional symmetrical shape.

In some embodiments, the material of the substrate 102 may include an insulating material or a semiconductor material. The shape of the three-dimensional symmetrical recess 108 and the shape of the metal shell 114 may include a hemispherical shape or a cube shape. The width (or the diameter) of the three-dimensional symmetrical recess 108 may be 0.8 to 0.9 times of a wavelength at which the negative refractive index effect to be generated. In addition, the three-dimensional negative refraction structure 100 may further include the pad layer 109. The pad layer 109 may be located on the portion of the substrate 102 outside the three-dimensional symmetrical recess 108 and may be located between the metal shell 114 and the three-dimensional symmetrical recess 108 (the pad layer 109 is omitted in FIG. 1J). The side of the substrate 102 opposite to the three-dimensional symmetrical recess 108 may include the back-side recess 116. In the present embodiment, a number of the three-dimensional symmetrical recess 108 and a number of the metal shell 114 may be singular, respectively.

In the present embodiment, when an electromagnetic wave normally propagates to the metal shell 114, a surface current SC1 may be generated on a sidewall of the metal shell 114 (as shown by solid arrows in FIG. 1J). In the present embodiment, the surface current SC1 may flow along the sidewall of the metal shell, so as to flow from a side of the metal shell 114 to an opposite side of the metal shell 114 through a bottom portion of the metal shell 114. A magnetic resonance at a certain wavelength is generated by the surface current SC1, so as to generate a magnetic dipole moment with a direction opposite to a direction of a magnetic field of the incident electromagnetic wave. As a result, the three-dimensional negative refraction structure 100 has a negative permeability at this wavelength.

In another aspect, when an electromagnetic wave normally propagates to the metal shell 114, a surface current SC2 may be generated on a top portion of the metal shell 114 (as shown by hollow arrows in FIG. 1J). The surface current SC2 may flow from a side of the metal shell 114 to an opposite side along the top portion of the metal shell 114. As a result, an electric dipole moment with a direction opposite to the direction of an electric field of the incident electromagnetic wave is generated at the above-mentioned wavelength. Moreover, a length of the electric dipole is equal to the diameter (or a width) of the metal shell 114. Such that, the three-dimensional negative refraction structure 100 has a negative permittivity at this wavelength. Hence, at this wavelength, a negative refractive index effect can be generated by the three-dimensional negative refraction structure 100 as a result of the negative permeability and the negative permittivity. That is, the three-dimensional negative refraction structure 100 has a negative refractive index at this wavelength.

The metal shell 114 is in a three-dimensional symmetrical shape. Thus, when electromagnetic waves propagate to the metal shell 114 with different incident angles (an incident angle refers to an angle between a direction of the incident electromagnetic wave and a normal direction of the substrate 102), the negative refractive index effect can be generated by the three-dimensional negative refraction structure 100 correspondingly. In addition, the wavelength at which the negative refractive index effect is generated by the three-dimensional negative refraction structure 100 may vary as the incident angle of the electromagnetic wave varies.

Specifically, when an electromagnetic wave obliquely enters the metal shell 114, a surface current may also be generated on the sidewall of the metal shell 114. This surface current is similar to the surface current SC1 shown in FIG. 1J, and can generate a magnetic dipole moment with a direction opposite to the direction of the incident electromagnetic wave as well. Particularly, as the incident angle of the electromagnetic wave increases, a path of the surface current being generated deviates more from a path of the surface current SC1 shown in FIG. 1J. Specifically, as the incident angle of the electromagnetic wave increases, the path of the surface current is elongated, such that a wavelength at which the magnetic resonance being generated increases. Therefore, when the incident angle of the electromagnetic wave increases, the three-dimensional negative refraction structure 100 has a negative permeability at a longer wavelength.

In another aspect, when an electromagnetic wave obliquely enters the metal shell 114, another surface current may be generated at the metal shell 114. This surface current is similar to the surface current SC2 as shown in FIG. 1J, which can generate an electric dipole moment with a direction opposite to the direction of the electric field of the incident electromagnetic wave as well. Particularly, this surface current also flows along the top portion of the metal shell 114, but a length of a path of this surface current is greater than or less than a length of a path of the surface current SC2. Thereby, a length of the electric dipole moment generated by this surface current is less than the diameter (or the width) of the metal shell 114. Therefore, a wavelength at which the electric resonance generated is shortened when the incident electromagnetic wave enters obliquely. Particularly, as the incident angle of the electromagnetic wave increases, the wavelength at which the electric resonance generated by the three-dimensional negative refraction structure 100 decreases. In other words, when the incident angle of the electromagnetic wave increases, the three-dimensional negative refraction structure 100 may have a negative permittivity at a shorter wavelength.

In view of the foregoing, a magnetic dipole moment with a direction opposite to the direction of the magnetic field of the incident electromagnetic wave as well as an electric dipole moment with a direction opposite to the direction of the electric field of the incident electromagnetic wave may both be generated when incident electromagnetic waves with different incident angles propagates to the metal shell 114. Particularly, as the incident angle of the electromagnetic wave increases, the three-dimensional negative refraction structure 100 has a negative permeability and a negative permittivity at a longer wavelength. In other words, the three-dimensional negative refraction structure 100 has a negative refractive index at a longer wavelength as the incident angle of the electromagnetic wave increases. On the other hand, if the incident angle of the electromagnetic wave is fixed, the wavelength at which the negative refractive index effect being generated by the three-dimensional negative refraction structure 100 may be adjusted by altering the width (the diameter) of the three-dimensional symmetrical recess 108 and the width (the diameter) of the metal shell 114.

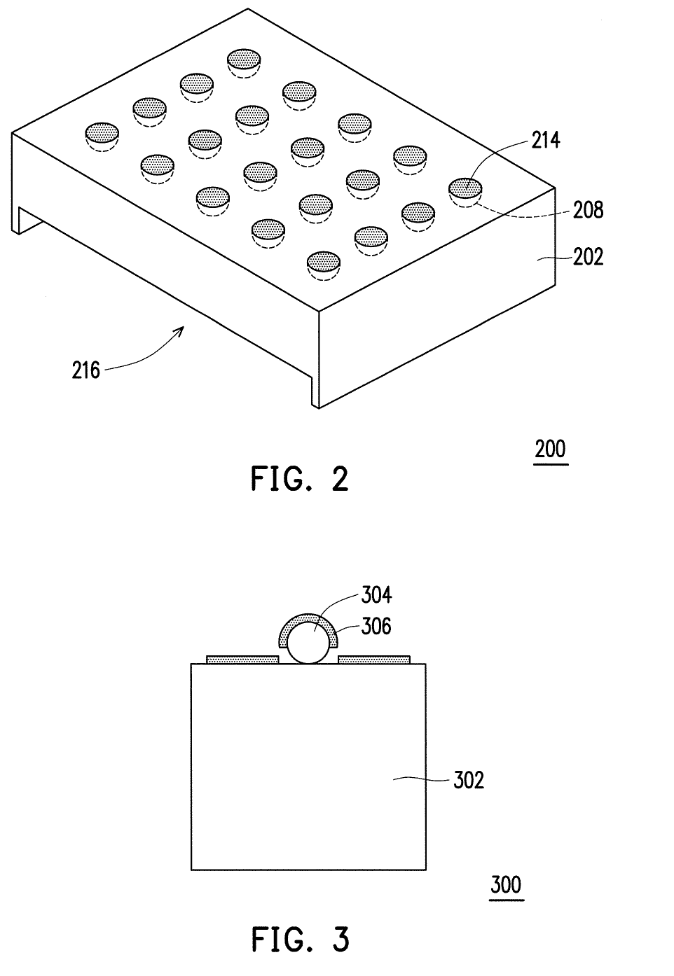

FIG. 2 is a schematic three-dimensional view of a three-dimensional negative refraction structure according to another embodiment of the invention. Referring to FIG. 2, a three-dimensional negative refraction structure 200 of the present embodiment is similar to the three-dimensional negative refraction structure 100 shown in FIG. 1J. Differences therebetween are illustrated below while similar or identical parts are omitted.

In the present embodiment, a substrate 202 has a plurality of three-dimensional symmetrical recesses 208, and a plurality of metal shells 214 are conformally disposed in the three-dimensional symmetrical recesses 208 respectively. In addition, the metal shells 214 may be arranged periodically. An interval between adjacent metal shells 214 may be 0.1 to 0.5 times of a wavelength at which the negative refractive index effect to be generated. In addition, the three-dimensional negative refraction structure 200 may further include a pad layer (not shown), which may be located on a portion of the substrate 202 outside the three-dimensional symmetrical recesses 208 and may be located between the metal shell 214 and the three-dimensional symmetrical recess 108. Furthermore, a side of the substrate 202 opposite to the three-dimensional symmetrical recesses 208 may have a back-side recess 216. In the present embodiment, the back-side recess 216 is disposed in correspondence with positions of the metal shells 214, so as to enhance transmittance of the three-dimensional negative refraction structure 200 for electromagnetic wave.

The negative refractive index effect can be generated by the three-dimensional negative refraction structure 200 when a beam width of an incident electromagnetic wave is less than an overall size of the metal shells 214. Thereby, a number of the metal shells 214 and the interval between adjacent metal shells 214 may be adjusted according to the beam width of the incident electromagnetic wave. Thus, the negative refractive index effect may as well be generated by the three-dimensional negative refraction structure 200 for electromagnetic waves with different beam widths.

FIG. 3 is a schematic cross-sectional view of a three-dimensional negative refraction structure according to still another embodiment of the invention. A three-dimensional negative refraction structure 300 of the present embodiment is similar to the three-dimensional negative refraction structure 100 shown in FIG. 1J, but a metal shell 306 of the present embodiment is disposed on a substrate 302.

A manufacturing method of the three-dimensional negative refraction structure 300 according to the present embodiment includes the following steps. A support structure 304 may be formed on the substrate 302. A shape of the support structure 304 is s a three-dimensional symmetrical shape, such as a spherical shape. A material of the support structure 304 may include an insulating material, such as polystyrene. In the present embodiment, one single support structure is formed. Nevertheless, a plurality of support structures separated from each other may also be formed on the substrate 302 in alternative embodiments. Subsequently, a metal shell 306 may be formed on the support structure 304. A method of forming the metal shell 306 is, for instance, to deposit a metal layer on the support structure 304. The metal shell is conformally formed on an exposed surface of the support structure 304, so as to form the metal shell 306.

In some embodiments, the support structure 304 and the metal shell 306 may be further transferred to another substrate after the metal shell 306 has been formed. A method of transferring the support structure 304 and the metal shell 306 includes rinsing a surface of the substrate 302 with a solution, then coating the solution containing the support structure 304 and the metal shell 306 onto another substrate, and removing the solution afterward. In alternative embodiments, the remaining metal layer on the original substrate 302 may be removed after the surface of the substrate 302 has been rinsed with a solution. Then, the solution containing the support structure 304 and the metal shell 306 is coated to the surface of the original substrate 302. Thereby, an interference generated by the remaining metal layer on the substrate 302 can be reduced.

To sum up, the shape of the metal shell is symmetrical in three dimensions. Thus, when an electromagnetic wave propagates to the three-dimensional negative refraction structure with different incident angles, an electric resonance and a magnetic resonance may both be generated at the metal shell, so that the three-dimensional negative refraction structure generates the negative refractive index effect. In addition, the wavelength at which the negative refractive index effect is generated by the three-dimensional negative refraction structure may be changed along with the incident angle of an electromagnetic wave. On the other hand, if the incident angle of the electromagnetic waves is fixed, the wavelength at which the negative refractive index effect being generated by the three-dimensional negative refraction structure may be adjusted by altering the width or the diameter of the metal shell.

It will be apparent to those skilled in the art that various modifications and variations can be made to the disclosed embodiments without departing from the scope or spirit of the invention. In view of the foregoing, it is intended that the invention covers modifications and variations provided that they fall within the scope of the following claims and their equivalents.

What is claimed is:

1. A three-dimensional negative refraction structure, comprising:
at least one metal shell, embedded in a substrate or disposed on the substrate, wherein a shape of the at least one metal shell is a three-dimensional symmetrical shape.

2. The three-dimensional negative refraction structure as claimed in claim 1, wherein the substrate has at least one three-dimensional symmetrical recess, and the at least one metal shell is conformally disposed in the at least one three-dimensional symmetrical recess.

3. The three-dimensional negative refraction structure as claimed in claim 2, wherein a shape of the at least one three-dimensional symmetrical recess and the shape of the at least one metal shell comprise a hemispherical shape or a cube shape.

4. The three-dimensional negative refraction structure as claimed in claim 1, further comprising at least one support structure, and the at least one metal shell conformally disposed on the at least one support structure, wherein a shape of the at least one support structure is a three-dimensional symmetrical shape.

5. The three-dimensional negative refraction structure as claimed in claim 4, wherein the shape of the at least one support structure comprises a spherical shape.

6. The three-dimensional negative refraction structure as claimed in claim 1, wherein a material of the substrate comprises an insulating material or a semiconductor material.

7. The three-dimensional negative refraction structure as claimed in claim 1, wherein a width of the at least one metal shell is 0.8 to 0.9 times of a wavelength at which a negative refractive index effect to be generated.

8. The three-dimensional negative refraction structure as claimed in claim 1, wherein a side of the substrate opposite to the at least one metal shell has a back-side recess.

9. The three-dimensional negative refraction structure as claimed in claim 1, wherein the at least one metal shell comprises a plurality of metal shells.

10. The three-dimensional negative refraction structure as claimed in claim 9, wherein a gap between adjacent metal shells is 0.1 to 0.5 times of a wavelength at which a negative refractive index effect to be generated.

11. A manufacturing method of a three-dimensional negative refraction structure, comprising:
embedding at least one metal shell in a substrate or forming the at least one metal shell on the substrate, wherein a shape of the at least one metal shell is a three-dimensional symmetrical shape.

12. The manufacturing method of the three-dimensional negative refraction structure as claimed in claim 11, further comprising forming a three-dimensional symmetrical recess at a surface of the substrate and forming the at least one metal shell conformally in the at least one three-dimensional symmetrical recess.

13. The manufacturing method of the three-dimensional negative refraction structure as claimed in claim 12, wherein a method of forming the at least one three-dimensional symmetrical recess comprises:
sequentially forming a first mask layer and a second mask layer on the substrate;
patterning the second mask layer to form at least one opening exposing the first mask layer;
patterning the first mask layer and removing the first mask layer exposed by the at least one opening;
removing the patterned second mask layer;
removing a portion of the substrate by using the patterned first mask layer as a mask to form the at least one symmetrical recess; and
removing the patterned first mask layer.

14. The manufacturing method of the three-dimensional negative refraction structure as claimed in claim 12, wherein a method of forming the at least one metal shell comprises:
conformally forming a metal layer on the substrate and the at least one three-dimensional symmetrical recess; and
removing a portion of the metal layer outside the at least one three-dimensional symmetrical recess on the substrate to form the at least one metal shell in the at least one three-dimensional symmetrical recess.

15. The manufacturing method of the three-dimensional negative refraction structure as claimed in claim 14, wherein a method of removing the portion of the metal layer comprises:
attaching an adhesion layer on the portion of the metal layer outside the at least one three-dimensional symmetrical recess; and
removing the adhesion layer and the portion of the metal layer attached to the adhesion layer all together to form the at least one metal shell in the at least one three-dimensional symmetrical recess.

16. The manufacturing method of the three-dimensional negative refraction structure as claimed in claim 14, further comprising forming a pad layer on the substrate and the at least one three-dimensional symmetrical recess before forming the metal layer.

17. The manufacturing method of the three-dimensional negative refraction structure as claimed in claim 16, wherein a material of the pad layer comprises silicon oxide, silicon nitride, or a combination thereof.

18. The manufacturing method of the three-dimensional negative refraction structure as claimed in claim 11, further comprising forming at least one support structure on the substrate and forming the at least one metal shell on the at least one support structure, wherein a shape of the at least one support structure is a three-dimensional symmetrical shape.

19. The manufacturing method of the three-dimensional negative refraction structure as claimed in claim 18, further comprising transferring the at least one support structure and the at least one metal shell to another substrate after forming the at least one metal shell.

20. The manufacturing method of the three-dimensional negative refraction structure as claimed in claim 11, further comprising removing a portion of the substrate to form a back-side recess on a side of the substrate opposite to the at least one metal shell.
